(19) United States
(12) Patent Application Publication
(10) Pub. No.: US 2015/0375137 A1
(43) Pub. Date: Dec. 31, 2015

(54) METHOD AND DEVICE FOR TREATMENT OF AN AMINO ACID SALT SOLUTION THAT IS CONTAMINATED WITH CARBON

(71) Applicant: SIEMENS AKTIENGESELLSCHAFT, München (DE)

(72) Inventors: Björn Fischer, Düsseldorf (DE); Stefan Hauke, Einhausen (DE); Ralph Joh, Seligenstadt (DE); Markus Kinzl, Dietzenbach (DE); Rüdiger Schneider, Eppstein (DE)

(73) Assignee: Siemens Aktiengesellschaft, Munich (DE)

(21) Appl. No.: 14/765,478

(22) PCT Filed: Jan. 17, 2014
(86) PCT No.: PCT/EP2014/050939

§ 371 Date: Aug. 3, 2015

(30) Foreign Application Priority Data
Feb. 5, 2013 (DE) 10 2013 201 833.9

(51) Int. Cl. B01D 9/00; B01D 53/14

(52) U.S. Cl. CPC B01D 9/0031; B01D 53/1425; B01D 9/0004; B01D 2252/20494

(57) ABSTRACT

A device and a method are for treatment of an amino acid salt solution that is contaminated with carbon dioxide and is an absorbent for carbon dioxide from a flue gas of a combustion, and includes a reaction process, a following filtration process and a following dissolution process. In the reaction process, carbon dioxide is introduced into the amino acid salt solution, and the amino acid salt solution is cooled. In this case crystalline carbonate and crystalline amino acid precipitate out. In the filtration process, the crystalline carbonate and the crystalline amino acid are filtered off. In the dissolution process the crystalline carbonate and the crystalline amino acid are dissolved in a solvent and a treated amino acid salt solution is thereby recovered.

### CROSS REFERENCE TO RELATED APPLICATIONS

This application is the US National Stage of International Application No. PCT/EP2014/050939 filed 17 Jan. 2014, and claims the benefit thereof. The International Application claims the benefit of German Application No. DE 102013201833.9 filed 5 Feb. 2013. All of the applications are incorporated by reference herein in their entirety.

### FIELD OF INVENTION

The invention relates to a method for treatment of a contaminated solution, in particular a contaminated alkaline amino acid salt solution as absorbent for carbon dioxide from a flue gas of a combustion of fossil fuels. The invention further relates to a device for treatment of a contaminated solution for absorption of carbon dioxide.

### BACKGROUND OF INVENTION

In fossil-fueled power plants generating electrical energy, a carbon dioxide-containing flue gas is formed by the combustion of a fossil fuel. To avoid or decrease carbon dioxide emissions, carbon dioxide must be separated off from the flue gases. To separate off carbon dioxide from a gas mixture, in general various methods are known. In particular, for separating off carbon dioxide from a flue gas after a combustion process, the method of absorption-desorption is customary. On the industrial scale, carbon dioxide is scrubbed out of the flue gas in this case using an absorbent.

In a classic absorption-desorption process, the flue gas is contacted in an absorption column with a selective absorbent as scrubbing medium, and absorbed here by the scrubbing medium. The absorbent then loaded with carbon dioxide is passed into a desorption column to separate off the carbon dioxide and regenerate the absorbent. The loaded absorbent is heated, with carbon dioxide being desorbed afresh from the absorbent and a regenerated absorbent being formed. The regenerated absorbent is passed back to the absorber column where it can again take up carbon dioxide from the carbon dioxide-containing exhaust gas.

Customary absorbents exhibit good selectivity and a high capacity for the carbon dioxide that is to be separated off. Absorbents that are particularly highly suitable are those based on amines such as, e.g., monoethanolamine. In the chemical industry also, amine solutions are generally used as absorbents. The absorbent comprises a solvent, for example water, in which the amines are dissolved as active scrubbing substance.

Owing to the contact of the absorbent with the flue gas, in addition to carbon dioxide, a large amount of contaminants are also introduced into the absorbent from the flue gas and flue gas byproducts. Also, owing to the constant thermal loading, in the course of time, the absorbent is damaged in an absorption-desorption process. Consequently, the absorbent must be continuously renewed. Owing to discharge of contaminated absorbents and absorbents admixed with degradation products, a comparatively large amount of unused absorbent is also continuously ejected from the absorption-desorption process.

In the use of amine-based absorbents, the amines can be recovered by distillation from the discharged absorbent. Amine solutions form stable salts with the acidic flue gas minor components. Via purification of the amine solution by distillation, that is to say by evaporating the more highly volatile amines and subsequent condensation thereof, separating off the high-boiling contaminants and thus purification of the amine solution is possible.

The appreciable vapor pressure of the amines, which is exploited for the purification by distillation, also means, however, that during the actual scrubbing process (absorption-desorption process) amines are discharged into the environment in a small proportion together with the purified flue gas, which leads to unwanted air pollution. The methods for purification by distillation in addition require a high energy consumption.

Amino acid salts, in contrast, do not exhibit a measurable vapor pressure and are therefore not discharged into the environment with the flue gas either. However, for this reason, workup of an amino acid salt solution by distillation is also not possible.

EP 2 409 755 A1 discloses a method for purification of an amino acid salt solution in which amino acid salt is recovered in a multistage purification process, and is then redissolved. In this case, in a first step, in a first reactor, with addition of carbon dioxide, first crystalline carbonate is precipitated out which is separated off by a first filter in a filtration process downstream of the first reactor. The solution from which carbonate has been removed by purification is cooled in a second step in a second reactor, in such a manner that crystalline amino acid (amino acid salt) precipitates out which is separated off in a second filtration process which is downstream of the second reactor. This exploits the fact that the crystallization behavior of amino acids is highly pH-dependent.

A disadvantage thereof is firstly the complexity of the purification process having a plurality of reactors and a plurality of filter processes which require high capital costs and complex process procedure. A disadvantage, secondly, is the high susceptibility to faults, since during transfer of the saturated amino acid salt solution by pumping from the first reactor into the second reactor, unwanted precipitation and blockage of piping pathways can occur owing to cooling of the amino acid salt solution in the pipes.

In order to ensure a simple and robust process procedure, for the filtration of carbonate and amino acid, various filters are expedient, since the salts of these two components form differing crystal shapes and particle sizes owing to the morphology thereof. In the case of a simultaneous filtration of both components in only one filter, it may be expected that the filter blocks rapidly and therefore impairs the filtration process. The reason for this is primarily the morphology of the salts and the relatively high solids content of the solid-liquid phase.

### SUMMARY OF INVENTION

An object of the invention is to cite a simplified method for treating a contaminated alkaline amino acid salt solution which eliminates in particular the disadvantages of the prior art and furthermore is usable on an industrial scale. A further object of the invention is to cite a simplified device for treatment of a contaminated alkaline amino acid salt solution which can be integrated into a carbon dioxide separation device.

An object of the invention that is directed to a method is achieved according to the invention by a method for treatment of an amino acid salt solution that is contaminated with carbon dioxide and is an absorbent for carbon dioxide from a flue gas of a combustion as claimed.

In the method, in a first process step, carbon dioxide is introduced into the amino acid salt solution in a reactor and the amino acid salt solution is simultaneously cooled here. As a result, crystalline carbonate precipitates out and crystalline amino acid precipitates out in parallel. In a second process step following the first process step, the crystalline carbonate and the crystalline amino acid are filtered off in a filter. In a third process step following the second process step, the crystalline carbonate and the crystalline amino acid are dissolved in a solvent, and a treated amino acid salt solution is recovered thereby.

The invention proceeds in this case from the consideration to have the carbonates and the amino acid crystallize out in a joint process step, and to filter them off from the liquid-solid phase in a further joint process step. The present invention is based on the surprising finding that, contrary to assumptions, the filter, even in the case of a filtration of both salts in one process step, does not become blocked in such a manner that the filtration process is disadvantageously impaired. In particular, the filters in this case have a pore size of less than or equal to 30 nm.

The contaminated alkaline amino acid salt solution is treated by selective crystallization. In this method, the pH dependence of the crystallization behavior of amino acids is exploited. The amino acid salt solutions used in absorption-desorption processes generally exhibit a very high pH of between approximately 10 and 13. Under these conditions, the amino acid is present as carboxylate. Owing to the negative charge of the carboxylate, it is readily soluble in water. The invention now provides reducing the water solubility of the amino acid by lowering the pH. The lowest water solubility is exhibited by amino acids at what is termed the isoelectric point. There, the amino acid is present as carboxylate form and ammonium form in equilibrium with one another (zwitterion). However, it need not be exactly the isoelectric point at which the crystallization proceeds with particularly high yield. The optimum pH for crystallization for typical amino acid salts is in the range from 6 to 10.

The use of carbon dioxide is particularly advantageous for lowering the pH, since carbon dioxide is a substance present in the overall process. Furthermore, the overall process comprises a desorption process, and so the carbon dioxide can be removed again from the treated amino acid salt solution in the desorption process, in order to achieve again the necessary alkalinity of the amino acid salt solution.

Depending on the reaction pathway which the amino acid salt preferentially takes, during the treatment with carbon dioxide gas, the carbamate of the amino acid, or else bicarbonate or carbonate is principally formed. In the case of bicarbonate-forming amino acid salts, the bicarbonate formed is often still less soluble than the amino acids themselves, and so already in the treatment of the alkali metal hydrogencarbonate with carbon dioxide gas, potassium hydrogencarbonate generally precipitates out. Owing to the simultaneous decrease in temperature, in addition the amino acid precipitates out in pure crystalline form.

By means of the method according to the invention, it is possible to recover amino acid salt from a contaminated amino acid salt solution in only one reaction step and only one filtration step. Owing to the savings of further reactors and further filters, and corresponding piping and process procedure, the simplified method is decreased in capital costs compared with the prior art. Also, the method according to the invention is more expedient in operation, since only one reactor need be temperature-conditioned or stirred. The method according to the invention additionally ensures great immunity to faults due to unwanted precipitation and blockage in the piping.

The method is also suitable for amino acid salt solutions in which the amino acid preferentially forms carbamate instead of bicarbonate.

In an advantageous optimization step of the method, the contaminated alkaline amino acid salt solution is concentrated before the introduction of carbon dioxide in such a manner that a concentrated amino acid salt solution is formed. As a result, firstly, less solvent needs to be transported and treated. Secondly, a higher yield of the crystallized amino acid is achievable. In addition, less amino acid salt remains in the remaining solution (mother liquor) which needs to be disposed of together with the contaminants that are separated off.

Concentration of the amino acid salt solution proceeds in this case advantageously by using superheated steam. This superheated steam is in particular a low-pressure steam which is available in the overall process of a carbon dioxide separation process. The overall process comprises a carbon dioxide separation device for which steam is likewise required for the desorption process. In addition, the overall process comprises a fossil-fueled power plant process in which superheated steam is generated for energy production. Using a suitable heat exchanger, energy is introduced with the superheated steam into the amino acid salt solution, with some of the water of the amino acid salt solution evaporating, in such a manner that the concentrated amino acid salt solution and steam are formed. The steam that is formed is condensed to form condensate and is used as solvent for dissolving the filtered-off and crystalline carbonate and carbon dioxide in the dissolution process.

The condensate is therefore advantageously reused for dissolving the filtered-off crystalline amino acid and/or the amino acid salt and thus for recovering a treated amino acid salt solution. The condensate is substantially kept in circuit thereby, as a result of which additional introduction of a solvent (such as water for example) is saved.

The method is used particularly advantageously integrated into a carbon dioxide separation process. The separation process comprises in this case an absorption process and a desorption process. As a result, it is advantageously possible that the carbon dioxide required for introduction into the method is withdrawn directly from the carbon dioxide desorption process. Thus a substance present in the overall process is utilized and the additional provision of a substance for lowering the pH can be dispensed with.

The desorption process present in the overall process can in this case likewise be advantageously utilized for desorbing afresh the carbon dioxide present in the treated amino acid salt solution in order thus to again reach the required alkalinity of the amino acid salt solution for the selective absorption of carbon dioxide in the absorption process of the separation process.

Filtering off the crystalline carbonate and the crystalline amino acid forms a depleted mother liquor. In a particularly advantageous development of the method, more than half of this mother liquor is returned back to the reaction step and introduced together with the carbon dioxide into the suspension resulting from the crystallization and thereby diluted. The dilution further supports in particular the downstream filtration process. This is because, owing to the proportion of the mother liquor returned to the reaction process, the filtration process is moderated. The fraction of mother liquor is selected in this case such that the solids fraction in the suspension is diluted to the extent that simultaneous filtration of the crystalline carbonate and the crystalline amino acid can be achieved without problems in one filter. This fraction which is returned to the reaction process particularly corresponds to between 30 and 90% of the total mother liquor produced.

The remaining fraction of mother liquor is further divided. A first part of the remaining fraction is introduced as a recycle stream into the concentration process to increase the yield. A second part of the remaining fraction is used to discharge residues from the process in a waste stream.

The method is a component of a carbon dioxide separation process which is integrated into a fossil-fueled power plant process. In particular, the contaminated amino acid salt solution is withdrawn from the absorbent circuit of the separation process, and the treated amino acid salt solution is fed back to the same absorbent circuit. The treated amino acid salt solution in this case is fed to a desorption process, with the carbon dioxide present in the treated amino acid salt solution being desorbed in the desorption process.

The object, directed towards a device, of the invention for treatment of an amino acid salt solution that is contaminated with carbon dioxide is achieved according to the invention as claimed. The advantages of the device and the respective developments correspond to the method according to the invention which can be carried out on the device.

The device comprises a crystallization reactor, a filter and a dissolver. The contaminated amino acid salt solution and carbon dioxide can be introduced into the crystallization reactor, in such a manner that owing to the contact between the amino acid salt solution and carbon dioxide substantially crystalline carbonate can be precipitated out. The crystallization reactor is, in addition, coolable, in such a manner that by cooling the amino acid salt solution substantially crystalline amino acid can be precipitated out. The filter is connected via a line to the crystallization reactor and serves for separating crystallized carbonate and crystallized amino acid from the amino acid salt solution that can be fed. The dissolver is connected to the filter. The crystallized carbonate and the crystallized amino acid and, in addition, a solvent, can be fed to the dissolver, in such a manner that by dissolving the carbonates and amino acid with the solvent a treated amino acid salt solution is formed.

The device is advantageously integrated into a carbon dioxide separation device and connected to the absorbent circuit of the separation device. The separation device here can itself be a component of a fossil-fueled power plant. The separation device comprises a store for carbon dioxide. The crystallization reactor is connected to the store via a line for feeding carbon dioxide, and to the absorbent circuit via a line for feeding the contaminated amino acid salt solution. The dissolver, for discharge of a treated solvent, is advantageously connected to the desorption unit of the carbon dioxide separation device.

In a further advantageous embodiment, the separation device comprises an evaporator which is upstream of the crystallization reactor and is connected for heating via a steam line to a steam generator of a fossil-fueled power plant. The evaporator is connected via a line to the dissolver, in such a manner that condensed steam can be fed as solvent to the dissolver. The condensed steam from the evaporator is therefore additionally usable and no additional component needs to be introduced from the outside as solvent.

A particularly advantageous further development of the device is that in which the filter is connected via a line to the crystallization reactor, in such a manner that at least one part of the lean amino acid salt solution that is formed in the filter can be returned to the crystallization reactor. As a result, dilution of the contaminated amino acid salt solution can be achieved.

### BRIEF DESCRIPTION OF THE DRAWINGS

The invention will be described in more detail hereinafter with reference to exemplary embodiments with reference to schematic drawings. In the drawings:

FIG. 1 shows a multistage method for treating a contaminated alkaline amino acid salt solution according to the prior art,

FIG. 2 shows a single-stage method for treating a contaminated alkaline amino acid salt solution according to an embodiment of the invention,

FIG. 3 shows a first development of the single-stage method having an upstream concentration process,

FIG. 4 shows a second development of the single-stage method having a return into the process of the lean amino acid salt solution produced,

FIG. 5 shows a device for treating a contaminated absorbent for carbon dioxide according to an embodiment of the invention and

FIG. 6 shows a further development of the device for treating a contaminated absorbent for carbon dioxide from FIG. 5.

### DETAILED DESCRIPTION OF INVENTION

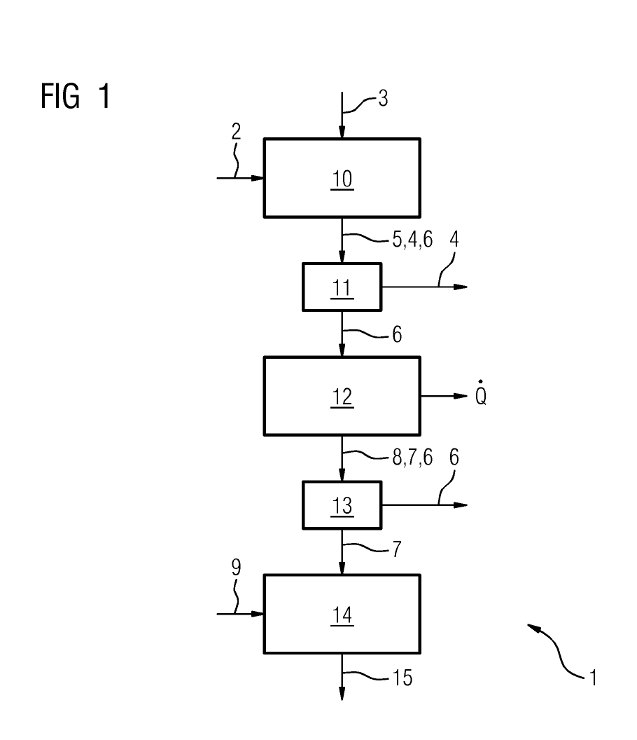

The treatment method 1 shown in FIG. 1 shows the purification of a contaminated amino acid salt solution in a plurality of reaction steps and filter steps of the prior art. This method requires substantially five sequential method steps.

In the first method step 10 of the treatment method 1, carbon dioxide 2 is introduced and, as mother liquor, a contaminated amino acid salt solution 3 is introduced. By contacting the contaminated amino acid salt solution 3 with the carbon dioxide 2, principally carbonate salts 4 and to a lesser extent amino acids or salts thereof precipitate out. A suspension 5 of carbonate salts and amino acids or salts 4 thereof and mother liquor 6 leaves the first method step 10 and is fed to the second method step 11.

In the second method step 11, precipitated solids 4, for example potassium hydrogencarbonate, are filtered off from the mother liquor 6 and discharged from the second method step 11 separately from the mother liquor 6. The precipitation in the first method step 10 and the filtration in the second method step 11 correspond here to one stage.

The mother liquor 6 is fed to the third method step 12. In the third method step 12, heat \dot{Q} is withdrawn from the mother liquor 6, as a result of which the mother liquor 6 cools and crystallization of principally amino acid and/or formation of amino acid salt 7 occurs. A suspension 8 of crystalline amino acid or amino acid salt and smaller proportions of carbonates 7 and mother liquor 6 leave the third method step 12 and are fed to the fourth method step 13.

In the fourth method step 13, the crystalline solids 7 are filtered off from the mother liquor 6 and discharged from the fourth method step 13 separately from the mother liquor 6. This filtercake which principally consists of crystalline amino acid or amino acid salt 7 is then fed to the fifth method step 14. The precipitation in the third method step 12 and the filtration in the fourth method step 13 correspond here to a further stage.

In the fifth method step 14, a treated amino acid salt solution 15 is recovered. For this purpose, the filtered-off solids from the second and fourth steps 7 and a solvent 9 are fed to the fifth method step 14 and the corresponding salts 7 are dissolved in the solvent. The treated amino acid salt solution 15 formed here is discharged from the fifth method step 14.

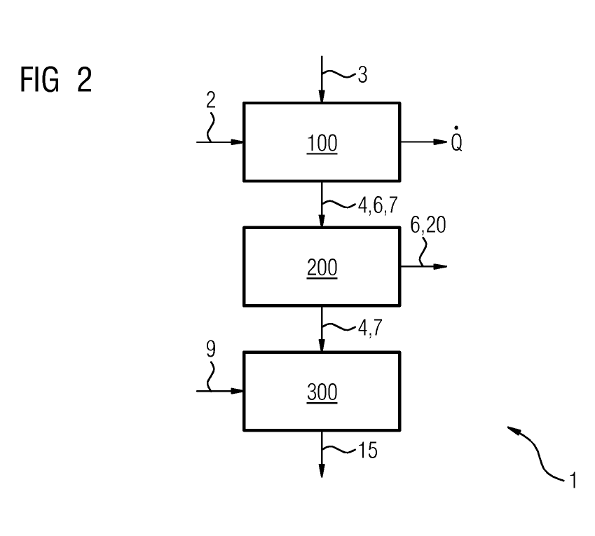

FIG. 2 shows the method 1 for purifying a contaminated amino acid salt solution according to an embodiment of the invention. The method according to the invention requires substantially only three successive method steps. Here, in particular method steps one and three of the prior art are combined with one another in a reaction process 100, and method steps two and four of the prior art are combined with one another in a filter process 200.

In a first process step, the reaction process 100, the amino acid salt solution 3 and carbon dioxide 2 are introduced. At the same time, the amino acid salt solution 3 is cooled. As a result, precipitation (crystallization) of crystalline carbonate 4 and crystalline amino acid 7 occurs. As a result, a suspension is formed of crystalline carbonate 4, crystalline amino acid 7 and mother liquor 6.

In a second process step, the filtration process 200, following the reaction process 100, the crystalline carbonate 4 and the crystalline amino acid 7 are filtered off from the mother liquor 6. The mother liquor 6 is discharged from the process.

In a third process step, the dissolution process 300, following the filtration process 200, the crystalline carbonate 4 and the crystalline amino acid 7 are redissolved in a solvent 9 and as a result a treated amino acid salt solution 15 is recovered. The method is single stage since only one reaction process 100 and one filtration process 200 are present.

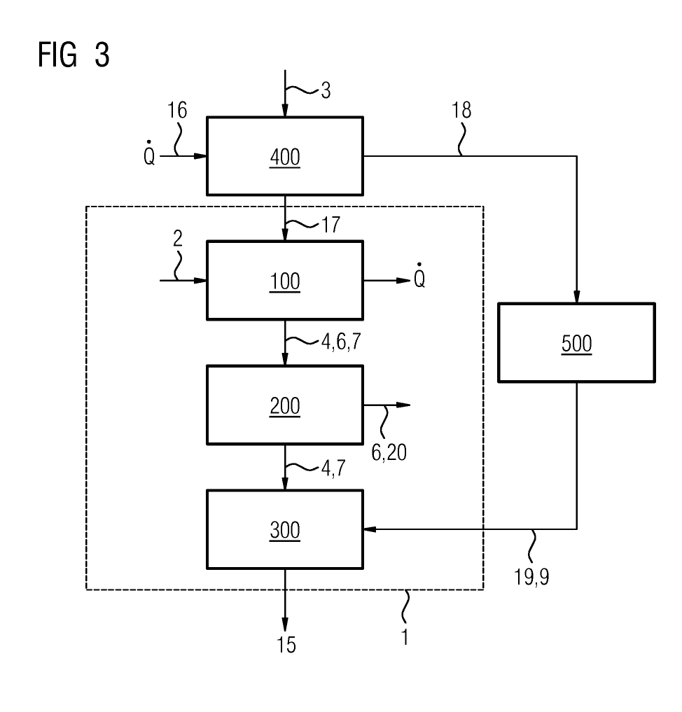

FIG. 3 shows an advantageous development of the treatment method 1 shown in FIG. 2. For this purpose, a concentration process 400 is connected upstream of the treatment method 1.

The contaminated amino acid salt solution 3 and heat energy \dot{Q} are supplied to the concentration process 400, as a result of which the contaminated amino acid salt solution 3 is concentrated. The heat energy \dot{Q} supplied can be transmitted with superheated steam which is provided by a steam generation process of a power plant process. Concentrating the contaminated amino acid salt solution 3 evaporates solvent, wherein steam 18 is formed. The steam 18 is condensed to form condensate 19 in a condensation process 500.

Owing to the evaporation of solvent, the remaining mother liquor is concentrated to form a concentrated amino acid salt solution 17. The concentrated amino acid salt solution 17 is fed to the downstream treatment method 1. The condensate 19 from the condensation process 500 is fed to the dissolution process 300. The condensate 19 serves here as solvent 9 for dissolving the carbonate salt 4 and the amino acid salt 7 and therefore for achieving a treated amino acid salt solution 15.

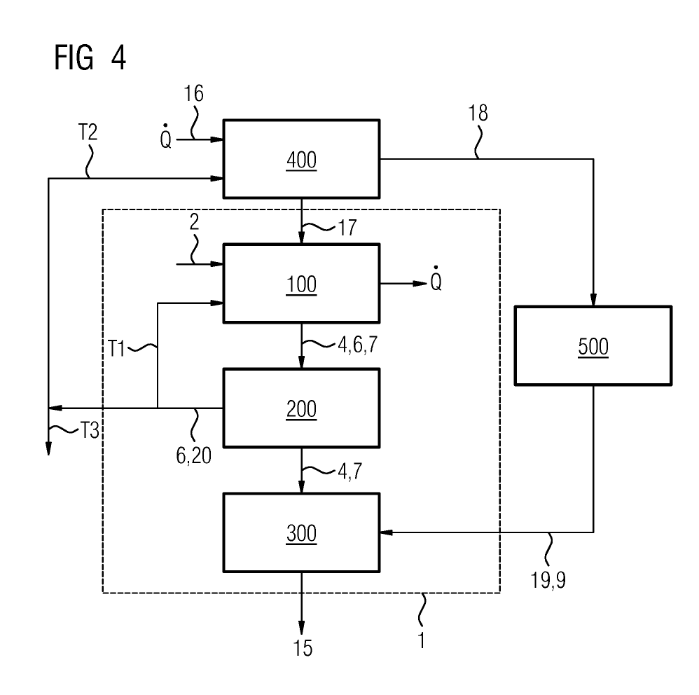

FIG. 4 shows a further particularly advantageous development of the treatment method 1 according to the invention. What are shown are substantially the reaction process 100, the filter process 200, the dissolution process 300, and, upstream of the reaction process 100, the concentration process 400 with the attached condensation process 500.

The mother liquor 6 which leaves the filtration process 200 is a depleted amino acid salt solution 20 since it contains only small amounts of dissolved amino acid salt. This lean amino acid salt solution 20 is divided into three substreams.

A first substream T1 which makes up more than half of the depleted amino acid salt solution is passed back to the reaction process 100 and dilutes the suspension 17. As a result of the dilution, the solids fraction of the suspension that is to be filtered does not become excessively high, and so a filtration can proceed without the filter in the filter process 200 blocking. The filter process 200 may be successfully operated if between 30 and 90% of the depleted amino acid salt solution 20 is used for diluting the suspension.

A second substream T2 is fed to the concentration process 400. By returning the lean amino acid salt solution 20 to the concentration process 400, the yield of the treatment method 1 can be further increased, and thus the losses of amino acid salt 7 decreased. The substream T2 is adjusted in dependence on the first substream T1. Particularly, the second substream T2 corresponds to a fraction of 5 to 60% of the total stream of depleted amino acid salt solution 20.

A third substream T3 forms a waste stream and is discharged from the process and disposed of. The third substream T3 is operated here in dependence on the substreams T1 and T2 and is particularly set to between 5 and 20%.

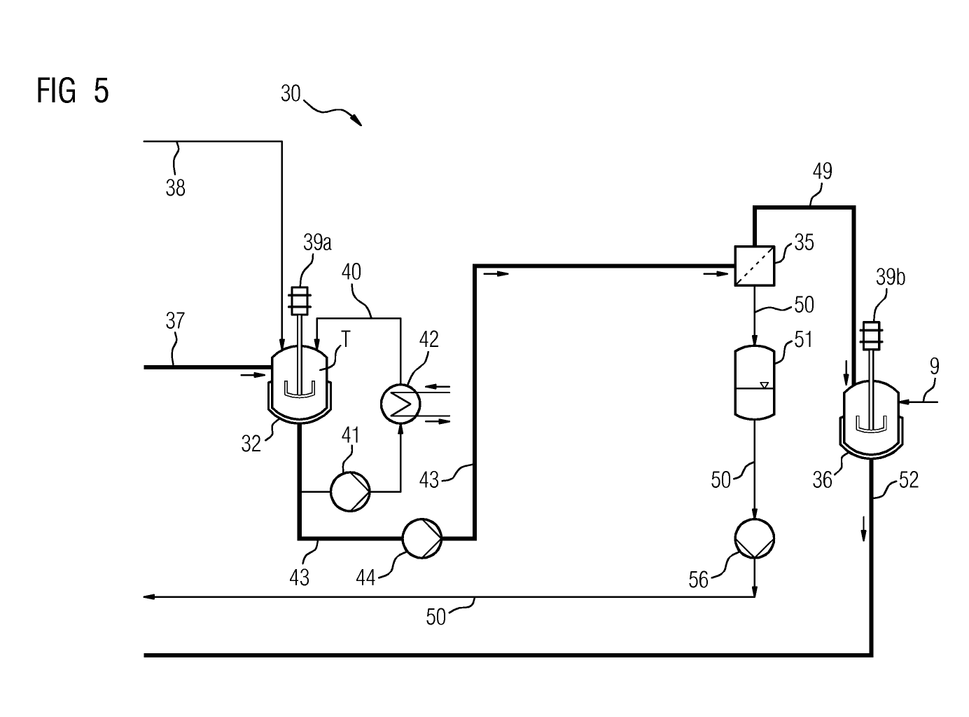

FIG. 5 shows an embodiment of the device 30 according to the invention for treating a contaminated absorbent for carbon dioxide. The important components of FIG. 5 are a reactor 32, a filter 35 and a dissolver 36.

The reactor 32 has a feed line 37 for a contaminated absorbent and a feed line for carbon dioxide 38. The feed line 37 is connected to a carbon dioxide separation device (CO2 capture plant) for feeding a contaminated absorbent. The carbon dioxide separation device is not shown here. The feed line 38 for carbon dioxide is likewise connected to the carbon dioxide separation device and serves for feeding carbon dioxide already separated off from a flue gas.

The reactor 32 comprises an agitator 39a and is connected into a cooling loop 40 in which a pump 41 and a cooler 42 are connected. Via the cooler 42, heat energy can be removed from the first reactor 32, whereby a temperature T in the reactor 32 is adjustable. Other concepts for adjusting the temperature T are also conceivable. For discharging a suspension, the reactor 32 has a line 43. The line 43 connects the reactor 32 to the filter 35. A pump 44 for conveying the suspension is connected into the line 43.

The carbonates and amino acid are already substantially completely precipitated out in the reactor 32. If a great cooling of the suspension proceeds in the line 43, no increase in the solids fraction is to be expected as a result, and as a consequence thereof, blockage of the line 43 is avoided.

The filter 35 is designed for separating off crystalline solids components, particularly potassium hydrogencarbonate and amino acid salt, from a liquid component. The filter 35 has an outlet line 49 for the transport of a filtered-off solids component, and an outlet line 50 for the discharge of a lean amino acid salt solution. A collecting vessel 51 and a pump 56 are connected into the outlet line 50. Via the outlet line 50, a depleted amino acid salt solution is discharged from the process.

The dissolver 36 is equipped with an agitator 39b, e.g. a disk agitator, which has the function of redissolving crystalline agglomerates. For this purpose a solvent, for example water, can further be fed to the dissolver 36. A return line 52 is connected to the dissolver 36, which return line, for discharging a treated absorbent, is connected to a carbon dioxide separation device (CO2 capture plant).

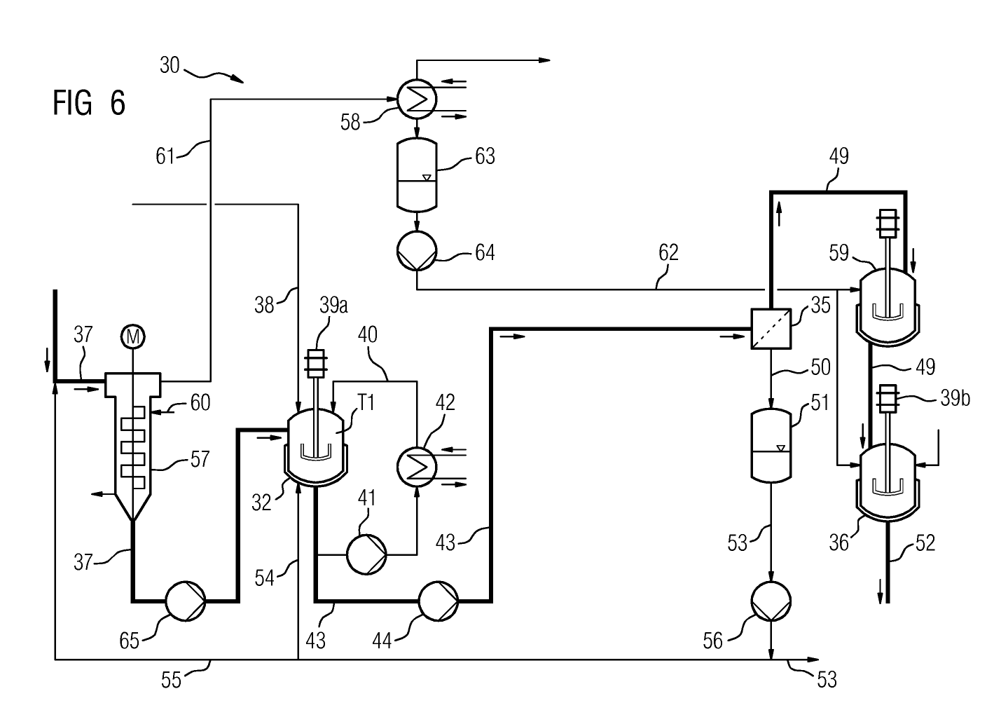

FIG. 6 shows a development of the device 30 shown in FIG. 5. In contrast to FIG. 5, the exemplary embodiment of FIG. 6 additionally comprises substantially an evaporator 57, a condenser 58 and a solids collector 59.

The evaporator 57 is designed as a film evaporator, and is connected into the feed line 37 for a contaminated absorbent. In addition, a steam line 60 is connected to the evaporator 57, which steam line connects the evaporator 57 to a steam generator of a fossil-fueled power plant.

The evaporation forms a concentrated amino acid salt solution which can be discharged from the evaporator 57 via the line 37. A pump 65 which can transport the concentrated amino acid salt solution into the reactor is connected into the line 37 between the evaporator 57 and the reactor 32.

Steam can be discharged from the evaporator 57 via a line 61. The line 61 connects the evaporator 57 to the condenser 58 in which the steam can be condensed. To the condenser 58 is connected a condensate line 62 which connects the condenser 58 to the solids collector 59 and the dissolver 36. A collecting vessel 63 for storing condensate, and a pump 64 for transporting condensate are connected into the condensate line 62.

For discharging a filtered-off solid, in the exemplary embodiment of FIG. 6, the filter 35 is connected via an outlet line 49 to the solids collector 59. In the solids collector 59, the filtered-off solids components are stored and delivered in a metered manner to the dissolver 36 via an outlet line 49. By means of the intermediate storage and the metered delivery, the dissolver 36 can be operated under constant conditions.

For discharging a mother liquor formed by the filtration, the outlet line 50 is connected to the filter 35. In the exemplary embodiment of FIG. 6, the outlet line 50 is shown in three sublines. The first substream line 54 connects the filter 35 to the reactor 32 and serves for returning a substream of mother liquor to the reactor 32. The second substream line 55 connects the filter 35 to the evaporator 57 and serves for returning a sub stream of mother liquor to the evaporator 57. The third substream line 53 serves for discharging a remaining liquid component.

The first substream line 54 here is designed to be of a size to the effect that more than half of the mother liquor to be discharged through the outlet line 50 can be conducted through the first substream line 54. The second substream line 55 and the third substream line 53 are designed having a smaller flow diameter in relation to the first substream line. Into the respective substream lines 53, 54 and 55, valves can be connected, by means of which the flow rate and division of the flow among the sublines can be adjusted.

1. A method for treatment of an amino acid salt solution that is contaminated with carbon dioxide and is an absorbent for carbon dioxide from a flue gas of a combustion, comprising in sequence:
in a reaction process, introducing carbon dioxide into the amino acid salt solution and cooling the amino acid salt solution, and thereby precipitating crystalline carbonate and crystalline amino acid,
in a filtration process, filtering off the crystalline carbonate and the crystalline amino acid,
in a dissolution process, dissolving the crystalline carbonate and the crystalline amino acid in a solvent and thereby recovering a treated amino acid salt solution.

2. The method as claimed in claim 1,
with the reaction process having an upstream concentration process in which the contaminated amino acid salt solution is concentrated such that a concentrated amino acid salt solution is formed.

3. The method as claimed in claim 2,
wherein heat is introduced into the amino acid salt solution by superheated steam for concentration in the concentration process, with some of the solvent of the contaminated amino acid salt solution being evaporated, such that a concentrated amino acid salt solution and steam are formed, and with the steam being condensed to form condensate and used as solvent for dissolving the filtered-off and crystalline carbonate and the crystalline amino acid in the dissolution process.

4. The method as claimed in claim 1,
wherein the carbon dioxide that is to be introduced is withdrawn from a desorption process of a separation device for carbon dioxide.

5. The method as claimed in claim 1,
wherein a depleted amino acid salt solution is formed as mother liquor in the filtration process by the crystallization of carbonate and the amino acid, and
wherein more than half of the mother liquor is fed back to the reaction process into the suspension in such that the suspension is diluted.

6. The method as claimed in claim 5,
wherein the remaining half of lean absorbent is divided and a first part is transferred to the concentration process and a second part is used for discharging residues to a waste stream.

7. The method as claimed in claim 1,
wherein the contaminated amino acid salt solution is withdrawn from an absorbent circuit of a carbon dioxide separation device, and
the treated amino acid salt solution is fed to the absorbent circuit.

8. The method as claimed in claim 1,
wherein the treated amino acid salt solution is fed to a desorption process of a carbon dioxide separation process, with the carbon dioxide present in the treated amino acid salt solution being desorbed in the desorption process.

9. The method as claimed in claim 1,
wherein the method is performed as a component of a carbon dioxide separation process which is integrated into a fossil-fueled power plant process.

10. A device for treatment of an amino acid salt solution that is contaminated with carbon dioxide and is an absorbent for carbon dioxide from a flue gas of a combustion, comprising:
a crystallization reactor into which the contaminated amino acid salt solution and carbon dioxide can be introduced, such that owing to the contact between the amino acid salt solution and carbon dioxide substantially crystalline carbonate precipitates out, and that the crystallization reactor is coolable such a manner that by cooling the amino acid salt solution substantially crystalline amino acid precipitates out,
a filter which is connected via a first line to the crystallization reactor, and to which amino acid salt solution can be fed for separating crystallized carbonate and crystallized amino acid, and
a dissolver which is connected via a second line to the filter, and to which the crystallized carbonate and the crystallized amino acid can be fed, and to which, in addition, a solvent can be fed, such that by dissolving the carbonates and amino acid with the solvent a treated amino acid salt solution is formed.

11. The device as claimed in claim 10, further comprising
a carbon dioxide separation device, with the separation device comprising an absorbent circuit and a store for carbon dioxide, and the crystallization reactor being connected to the store via a third line for feeding carbon dioxide, and being connected to the absorbent circuit via a fourth line for feeding the contaminated amino acid salt solution.

12. The device as claimed in claim 10, further comprising
an evaporator which is upstream of the crystallization reactor and is connected for heating via a steam line to a steam generator of a fossil-fueled power plant.

13. The device as claimed in claim 12,
wherein the evaporator is connected via a fifth line to the dissolver, such that condensed steam can be fed as solvent to the dissolver.

14. The device as claimed in claim 10,
wherein the filter is connected via a sixth line to the crystallization reactor, such that at least one part of the lean amino acid salt solution that is formed in the filter can be returned to the crystallization reactor, such that the contaminated amino acid salt solution can be diluted.

15. The device as claimed in claim 10,
wherein the crystallization reactor is connected to a store for carbon dioxide which is part of a carbon dioxide separation device integrated into the fossil-fueled power plant, such that carbon dioxide can be fed to the crystallization reactor.

16. The device as claimed in claim 10,
wherein the dissolver, for discharge of a treated solvent, is connected via a return line to a desorption unit of the carbon dioxide separation device.
